(19) United States
(12) Patent Application Publication
(10) Pub. No.: US 2006/0053268 A1
(43) Pub. Date: Mar. 9, 2006

(54) Storing bios in persistent system memory

(75) Inventors: Wihelmus Franciscus Johannes Fontijn, Eindhoven (NL); Nicolaas Lambert, Eindhoven (NL); Robert Jochemsen, Eindhoven (NL); Adrianus Johannes Maria Denissen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/533,752

(22) PCT Filed: Oct. 8, 2003
(86) PCT No.: PCT/IB03/04456

§ 371 Date: May 4, 2005

(30) Foreign Application Priority Data
Nov. 6, 2002 (EP) 020796272

(51) Int. Cl. G06F 15/00; G06F 15/76

(52) U.S. Cl. 712/1

(57) ABSTRACT

When booting a personal computer, it needs to find instructions immediately to tell it what to run to start up the personal computer. These it finds within the so-called basic input/output system (BIOS) program. Usually the BIOS program is stored in a separate location, for example a ROM. It is usually shadowed into system memory (SM) to speed up its operation. The copying of the BIOS program to system memory (SM), amongst others, causes the boot process to be a relatively slow process. In the present invention, the system memory (SM) comprises a persistent system memory (PSM) and the BIOS program is stored in the persistent system memory (PSM). Furthermore, selected information used by the BIOS program is stored in persistent system memory (PSM) as well. As a result, the speed of booting the personal computer is significantly increased.

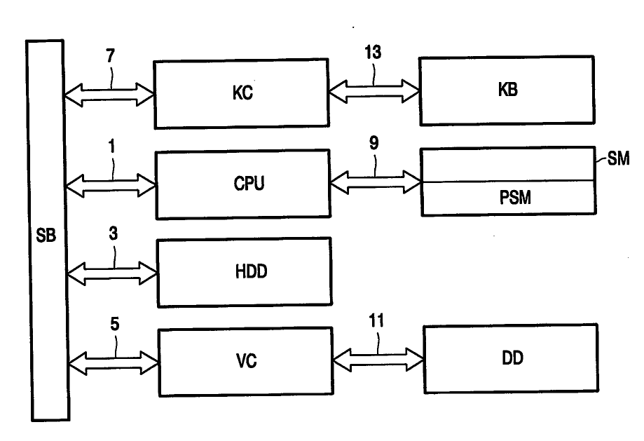

### TECHNICAL FIELD

The invention relates to a personal computer comprising a system memory and a basic input/output system program.

The invention further relates to a method for booting said personal computer.

### BACKGROUND ART

In general, a personal computer is equipped with a system memory. Usually, the programs that are executed or the files that are accessed by the personal computer are copied into the system memory. When starting up, i.e. booting, a personal computer, it needs to find instructions immediately to tell the personal computer what to run to start up. These it finds within the so-called basic input/output system (BIOS) program. To boot up the personal computer is one of the most important functions that the BIOS plays. The boot process executed when the personal computer is turned on is usually referred to as a cold boot, whereas the boot process executed using {Ctrl}+{Alt}+{Delete} or similar is referred to as a warm boot.

EP1028371 describes a personal computer, comprising a BIOS read-only memory (ROM) comprising a flash memory storing a BIOS program. The personal computer further comprises a central processing unit, a system memory and a local bus. The central processing unit has to access the BIOS program via the system bus.

It is a disadvantage of the prior art personal computer that accessing the BIOS program via the system bus or copying the BIOS program to the system memory for execution are relatively slow processes, resulting in a relatively long time period required for booting the personal computer.

### DISCLOSURE OF INVENTION

An object of the invention is to provide a personal computer with an improved booting process.

This object is achieved with a personal computer of the kind set forth, characterized in that the system memory comprises a persistent system memory and that the basic input/output system program is stored in the persistent system memory. When booting the personal computer according to the invention, the BIOS program can be directly executed from the persistent system memory. There is no need to access a separate memory storing the BIOS program, or to copy the BIOS program to the system memory. As a result, the booting process is significantly accelerated. Furthermore, no separate memory is required for storing the BIOS program. The present invention can be used in combination with any operating system.

An embodiment of the personal computer according to the invention is characterized in that non-volatile information required during execution of the basic input/output system program is stored in the persistent system memory. Execution of the BIOS program may involve steps of copying data, e.g. the BIOS program from a video controller, to the system memory. In case the personal computer has not changed since the last cold boot, e.g. no new video controller has been installed, the data has not changed since then as well. By storing this type of non-volatile information in the persistent system memory, this data need not to be copied to the system memory during each cold boot. As a result, the speed of the booting process is further increased.

An embodiment of the personal computer according to the invention is characterized in that the persistent system memory comprises a magnetic random access memory. An advantage of this embodiment is that magnetic random access memory is a persistent memory that is capable of operating at a high speed, which is favorable for reducing the time period required for booting the personal computer.

According to the invention a method for booting said personal computer, is characterized in that the basic input/output system program is executed from the persistent system memory. As a result, a fast booting process is obtained, decreasing the time period required for booting the personal computer.

An embodiment of said method for booting a personal computer, is characterized in that the basic input/output system program uses the non-volatile information during its execution. An advantage of this embodiment is that it further increases the speed of the booting process, by using the non-volatile information stored in the persistent system memory instead of copying this information from various sources to the system memory.

### BRIEF DESCRIPTION OF THE DRAWINGS

The FIGURE shows a schematic diagram of an embodiment of a personal computer according to the invention.

### DESCRIPTION OF EMBODIMENTS

Referring to the FIGURE, a schematic block diagram illustrates a personal computer, comprising a central processing unit CPU, a hard disk drive HDD, a system memory SM, a system bus SB, a video controller VC, a display device DD, a keyboard controller KC and a keyboard KB. The system memory SM comprises a persistent system memory PSM. The system bus SB is coupled to the central processing unit CPU via coupling 1, to the hard disk drive HDD via coupling 3, to the video controller VC via coupling 5, and to the keyboard controller via coupling 7. The central processing unit CPU is coupled to the system memory SM via coupling 9. The video controller VC is coupled to the display device DD via coupling 11. The keyboard controller KC is coupled to the keyboard KB via coupling 13. The keyboard controller KC, the central processing unit CPU, the hard disk drive HDD and the video controller VC are coupled via the system bus SB.

In other embodiments, the personal computer may comprise different devices, including a floppy disk drive, a printer, a mouse, a modem and a CD-ROM player, for example.

The BIOS program is stored in the persistent system memory PSM, and this program determines what the personal computer can do without accessing programs from the hard disk drive HDD. One of the most important functions that the BIOS program plays is to boot up the personal computer, using the BIOS boot program. When the personal computer is turned on it needs to find instructions immediately to tell the personal computer what to run in order to start up and these instructions it finds within the BIOS program. After the personal computer is turned on, the central processing unit CPU is pre-programmed to look at the place in the persistent system memory PSM, via coupling 9, to look for the start of the BIOS boot program. Subsequently the BIOS boot program can be executed by the central processing unit CPU. In case the BIOS program changes, for example due to a new update of the program, the new version of the BIOS program is stored in the persistent system memory PSM. The BIOS program is executed directly from the persistent system memory PSM, which increases the speed of operation. Furthermore, no separate memory is necessary for storing the BIOS program, e.g. a ROM or a flash memory.

Preferably, the persistent system memory PSM comprises a magnetic random access memory (MRAM). MRAM allows a fast memory access, allowing the central processing unit CPU to retrieve the instructions from the persistent system memory PSM at a high speed, resulting in an increase in the performance of the personal computer during the boot process.

In an advantageous embodiment, non-volatile information that is required during execution of the BIOS program is stored in the persistent system memory PSM as well. This non-volatile information may consist of the video controller's VC built in BIOS program, built in BIOS programs of any other devices of the personal computer, the boot device identification, a copy of the system set-up parameters, information on the initialization of the boot device, i.e. master boot record or volume boot sector, and the interrupt handlers. If the set-up of the personal computer did not change since the last cold boot, the non-volatile information stored in the persistent system memory PSM is used by the BIOS program during the boot process. The central processing unit CPU retrieves this information by accessing the persistent system memory PSM via coupling 9. As a result, the BIOS program does not need to copy this information from its various sources to the system memory SM, allowing a faster boot process.

A method for booting a personal computer according to the invention, and having a hard disk drive HDD as boot device, comprises the following steps:
Internal power supply turns on and initializes.
Central processing unit CPU accesses the persistent system memory PSM, via coupling 9, and starts executing the BIOS program.
The system set-up parameters of the personal computer, usually present in a complementary metal oxide semiconductor (CMOS) memory, are read by the BIOS program and compared to the version of the system set-up parameters stored in the persistent system memory PSM. In case all these parameters are identical, it is assumed that the set-up of the personal computer has not changed since the last boot and a “set-up identical” (SI) flag is set by setting a dedicated bit value to one. In case not all parameters are identical, the SI flag is not set, i.e. the dedicated bit value is set to zero. In different embodiments a dedicated flag is used to indicate if the system set-up parameters as usually stored in a CMOS memory have changed. If this is the case, the system set-up parameters are read by the BIOS program and compared to the version of the system set-up parameters stored in the persistent system memory PSM. If the system set-up parameters have not changed, the SI flag can be set directly. If the SI flag is set, the boot device is identified from the value stored in the persistent system memory PSM, and initialization of the boot device is started in parallel to other actions to be performed in the booting process. For initialization of the boot device, the master boot record is used as stored in the persistent system memory PSM. In case the SI flag is not set, a new copy of the system parameters is made into the persistent system memory PSM.
The interrupt handlers, which abstract the hardware components from the operating system, are loaded into the system memory SM. If the SI flag is set, these interrupt handlers are retrieved from the persistent system memory PSM. If the SI flag is not set, a new copy of the interrupt handlers is made in the persistent system memory PSM.
The power-on self test (POST) routine is run.
The presence of a video controller VC is checked and the video controller's BIOS program is executed, in order to initialize the video controller. If the SI flag is set, the video controller's BIOS program stored in the persistent system memory PSM is used. If the SI flag is not set, a new copy of the video controller's BIOS program is made in the persistent system memory PSM, and subsequently executed.
The presence of other devices of the personal computer, having a BIOS program, is checked and their corresponding BIOS programs are executed. If the SI flag is set, the corresponding BIOS programs stored in the persistent system memory PSM are used. In case the SI flag is not set, new copies of the corresponding BIOS programs are made in the persistent system memory PSM, and subsequently executed.
Memory count-up test is performed. In different embodiments, this test may not be performed.
Tests are performed to determine what sort of hardware is present in the personal computer, for example the presence of a keyboard and a mouse is checked. The BIOS program will also search for and label logical devices, such as serial communication ports and printer ports.
Initialization of the boot device. In case the SI flag is set, this initialization has already started. If the SI flag has not been set, the BIOS program identifies the hard disk drive HDD as the boot device by searching for a drive to boot from. A new copy of the boot device identification is made in the persistent system memory PSM. The master boot record stored in the persistent system memory PSM is used for initialization of the boot device. As soon as the boot device becomes responsive, the version of the master boot record stored on the hard disk drive HDD is compared to the version stored in the persistent system memory PSM. In case these versions are not identical, the version stored on the hard disk drive HDD is copied to the persistent system memory PSM. Subsequently, the initialization of the boot device is started again, using the master boot record stored in the persistent system memory PSM. Afer initialization of the boot device the operating system stored on the hard disk drive HDD is loaded into the system memory SM.

The master boot record stores information on how to boot the hard disk drive HDD and initiates loading the operating system from the hard disk drive HDD into the system memory SM. The master boot record comprises the following structures: master partition table, which is a small table containing the descriptions of the partitions that are contained on the hard disk drive HDD, and master boot code, which is a small initial boot program executed by the BIOS program in order to start the boot process for the operating system. This program eventually transfers control to the boot program stored on an arbitrary location on the hard disk drive HDD, and which is used for actually loading the operating system into the system memory SM.

In different embodiments, a floppy disk drive acts as the boot device and in that case the volume boot sector is stored in the persistent system memory PSM and used for initialization of the boot device, instead of the master boot record.

The above mentioned method for booting a personal computer allows to run the BIOS program from the persistent system memory, increasing the speed of execution and decreasing the time period required for booting the personal computer. Furthermore, in case the set-up of the personal computer has not changed, information required by the BIOS program can be directly retrieved from the persistent system memory PSM. Since the set-up of a personal computer usually remains identical during a longer period of time, the speed of the boot process will be further increased in most cases. This method can be generally applied, i.e. is not restricted to one type of operating system, and can also be used in multi-boot scenarios, i.e. for a personal computer that uses more than one type of operating system.

The steps described in the method for booting a personal computer according to the invention, are the steps that typically occur in a boot sequence. In other embodiments, different steps may occur, depending on which devices are present in the personal computer, the BIOS program itself and the manufacturer of the hardware.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

1. A personal computer comprising:
a system memory,
a basic input/output system program, characterized in that the system memory comprises a persistent system memory and that the basic input/output system program is'stored in the persistent system memory.

2. A personal computer according to claim 1, characterized in that non-volatile information required during execution of the basic input/output system program is stored in the persistent system memory.

3. A personal computer according to claim 1, characterized in that the persistent system memory comprises a magnetic random access memory.

4. A method for booting a personal computer according to claim 1, characterized in that the basic input/output system program is executed from the persistent system memory.

5. A method for booting a personal computer according to claim 2, characterized in that the basic input/output system program uses the non-volatile information during its execution.
